(19) United States
(12) Patent Application Publication
(10) Pub. No.: US 2025/0038239 A1
(43) Pub. Date: Jan. 30, 2025

(54) MEMBRANE-ELECTRODE ASSEMBLY WITH SEALED FRAME

(71) Applicant: Carl Freudenberg KG, Weinheim (DE)

(72) Inventors: Christian QUICK, Weinheim (DE); Pascal WAHLE, Burgberg (DE); Katharina HENGGE, Munich (DE); Tilman JURZINSKY, Munich (DE); Florian MACK, Traunstein (DE); Ashwin RANGARAJAN, Munich (DE)

(21) Appl. No.: 18/717,032

(22) PCT Filed: Dec. 8, 2022
(86) PCT No.: PCT/EP2022/084995

§ 371 Date: Jun. 6, 2024

(30) Foreign Application Priority Data
Dec. 10, 2021 (DE) 10 2021 132 696.6

(51) Int. Cl. H01M 8/1004

(52) U.S. Cl. CPC H01M 8/1004

(57) ABSTRACT

A unit, including an assembly of two gas diffusion electrodes, between which a membrane is sandwiched. The assembly is sealingly connected by a first seal to a frame enclosing the assembly at an outer periphery thereof. The frame includes two opposite end faces. The frame includes duct-like apertures extending from a first end face of the two opposite end faces to a second end face of the two opposite end faces of the frame. The apertures are enclosed by second seals at the end faces on both sides of the frame and are sealed off with respect to each other.

### CROSS REFERENCE TO RELATED APPLICATIONS

This application is a U.S. National Phase application under 35 U.S.C. § 371 of International Application No. PCT/EP2022/084995, filed on Dec. 8, 2022, and claims benefit to German Patent Application No. 10 2021 132 696.6, filed on Dec. 10, 2021. The International Application was published in German on Jun. 15, 2023 as WO/2023/104970 A2 under PCT Article 21 (2).

### FIELD

The invention relates to an assembly of two gas diffusion electrodes.

### BACKGROUND

A membrane-electrode unit is known from DE 10 2013 014 083 A1. The assembly of the unit is enclosed by the frame at the outer periphery thereof in a spaced relationship, wherein the seal is arranged in the gap formed by the space, which sealingly connects the assembly to the frame. The membrane-electrode unit is provided for a fuel cell.

The frame has a sandwich structure, just like the assembly, and comprises two outer frame portions between which an inner frame portion is arranged.

The assembly is connected to the frame by using a pressing process at elevated temperatures. The sealing material of the seal is disposed in the pressing direction between the outer frame portions prior to performing the pressing process and thus limits the distance to the assembly. During the pressing process, the outer frame portions are moved towards each other until each of them contacts the inner frame portion in an adjacent manner. In the process, the flowable sealing material is pressed into the gap formed by the space until the gap is sealed off and the sealing material penetrates into the boundary of the adjacent assembly. This forms the membrane-electrode unit as a composite formed by the assembly and the frame by means of the seal.

The membrane-electrode unit is retained within the frame by means of the seal.

### SUMMARY

In an embodiment, the present disclosure provides a unit, comprising an assembly of two gas diffusion electrodes, between which a membrane is sandwiched. The assembly is sealingly connected by a first seal to a frame enclosing the assembly at an outer periphery thereof. The frame includes two opposite end faces. The frame includes duct-like apertures extending from a first end face of the two opposite end faces to a second end face of the two opposite end faces of the frame. The apertures are enclosed by second seals at the end faces on both sides of the frame and are sealed off with respect to each other.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

### SHORT DESCRIPTION OF THE DRAWINGS

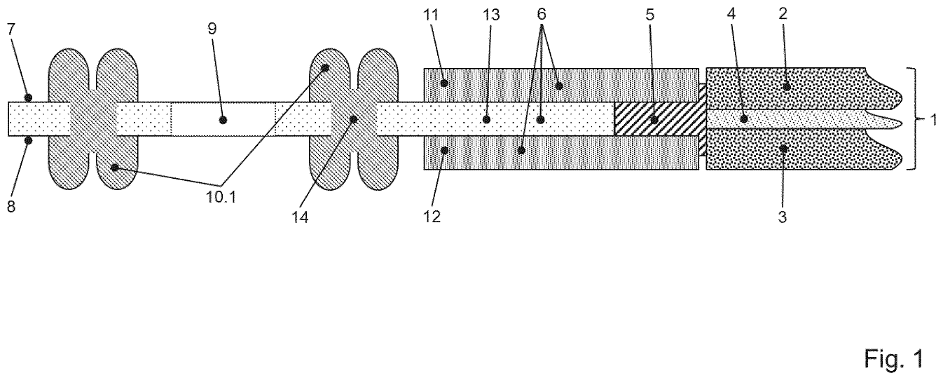

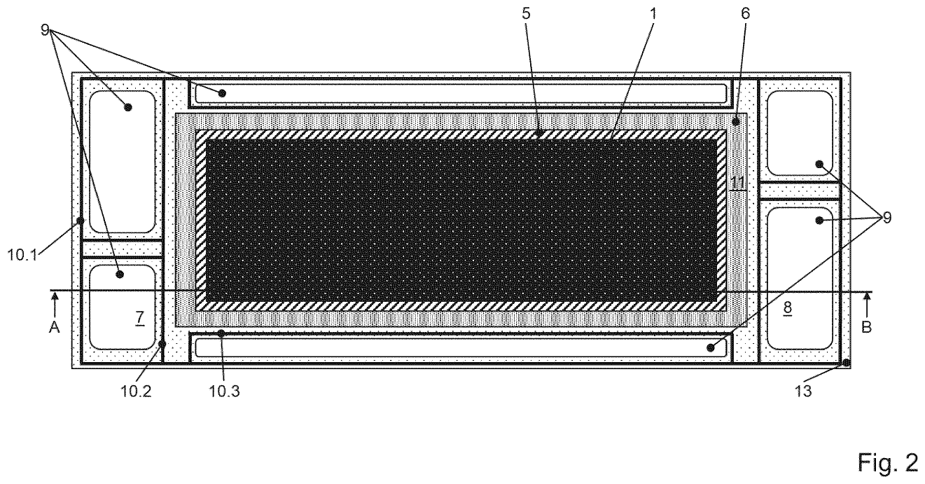

An exemplary embodiment of the unit according to the invention will be described in more in detail in the following with reference to the schematic drawing FIGS. 1 and 2. In the drawings:

FIG. 1 shows a schematic sectional view of the membrane-electrode unit along line A-B of FIG. 2; and

FIG. 2 shows a plan view of the unit of FIG. 1.

### DETAILED DESCRIPTION

In an embodiment, the present invention provides a further developed unit of the initially mentioned type in such a manner that an electrochemical cell operated therewith, in particular a fuel cell, has a further simplified structure and has further increased ease of manufacture at further reduced manufacturing cost.

To achieve the foregoing, a unit is provided, comprising an assembly of two gas diffusion electrodes, between which a membrane is sandwiched, wherein the assembly is sealingly connected by means of a first seal to a frame enclosing the assembly at the outer periphery thereof, and wherein the frame includes two opposite end faces, wherein the frame includes duct-like apertures extending from the first end face to the second end face of the frame and wherein the apertures are enclosed by second seals at the end faces on both sides of the frame and are sealed off with respect to each other during the intended use of the unit.

It is advantageous that the unit is formed to be multifunctional and thus provides further functions whereby an electrochemical cell, for example a fuel cell, with a cost-effective structure and a minimum number of parts is made possible.

The unit is formed as a membrane-electrode unit.

Usually, a membrane-electrode unit, as known from the state of the art and initially described, has to be sealed by additional and separately formed seals within an electrochemical cell, for example a fuel cell. The production and assembly of the seals makes the manufacture of the cell cumbersome and expensive. Moreover, the functioning of the cell can be further negatively affected by assembly errors involving the further seals.

In the unit according to an embodiment of the invention, these drawbacks are avoided. To do this, the frame comprises the duct-like apertures extending from the first to the second end face of the frame, wherein the apertures are enclosed by second seals at the end faces on both sides of the frame.

The assembly and the second seals form a pre-assembled unit.

The apertures in the frame, during the use of the unit in a fuel cell, are formed to be coinciding with the openings in the bipolar plates adjacent at the end faces on both sides, wherein the openings in the bipolar plates are formed by coolant inlets and outlets and gas inlets and outlets.

By the apertures and the second seals sealing off the apertures forming an integral component of the unit, the production and the assembly of an electrochemical cell is cost-effective and simplified.

Alternatively, a unit can be used, comprising an assembly of two gas diffusion layers, between which a catalyst-coated membrane is sandwiched, wherein the assembly is sealingly connected by a first seal to a frame enclosing the assembly at the outer periphery thereof, and wherein the frame includes two opposite end faces, wherein the frame includes duct-like apertures extending from the first end face to the second end face of the frame and wherein the apertures are enclosed by second seals at the end faces on both sides of the frame and are sealed off with respect to each other during the intended use of the unit.

In accordance with an advantageous embodiment, it can be provided that the second seals are formed of an elastomeric sealing material. Elastomeric sealing materials are commonly cost-effectively available in accordance with many specifications.

At least two, further preferably all, of the second seals can be contiguous in an integral manner and made of one and the same material. It is advantageous that the at least two, further preferably all, of the seals are manufacturable in only a single method step and that, due to their integral structure, changeovers between adjacent second seals and thus consequently any risk of leakages between the second seals is avoided.

The second seals can be profiled.

The frame preferably has a sandwich structure and comprises two outer frame portions between which an inner frame portion is arranged. Such a frame structure has the advantage, as initially described, that the first seal establishes a sealing connection between the assembly and the frame of the unit by being pressed between the outer frame portions.

The frame structure can be, for example, of a thermoplastic film material, such as polyester.

The inner frame portion protrudes beyond the outer frame portions at the outer periphery thereof and thus forms a protrusion on the frame. The apertures are arranged in this protrusion.

The second seals are sealingly connected to the inner frame portion and sealingly enclose the apertures during the intended use of the electrochemical cell in which the unit will ultimately be used.

To achieve a durable and sealing connection between the second seals and the inner frame portion, the second seals are preferably adhesively and/or interlockingly connected to the inner frame portion. To achieve this, it can be provided that the second seals are injection-molded onto the inner frame portion. This results in an adhesive connection.

An interlocking connection between the second seals and the inner frame portion can be achieved by the inner frame portion having attachment apertures penetrated by the sealing material of the second seals during their production. This produces the second seals in a simple manner, which are arranged at the end faces on both sides of the inner frame portion.

The above-described concept is applicable in a corresponding manner to fuel cells as well as to electrolysers or redox-flow batteries.

A fuel cell is fed with hydrogen and oxygen, so that water and energy is produced.

Conversely, an electrolyser is fed with water and energy, so that hydrogen and oxygen are produced.

A redox-flow battery processes electrolytic liquids in a chemical reaction (redox reaction) which provides useful electrical energy.

FIGS. 1 and 2 show an exemplary embodiment of the unit according to the invention.

FIG. 1 shows the section along line A-B of FIG. 2.

The unit comprises the assembly 1 formed by the two gas diffusion electrodes 2, 3 and the membrane 4, wherein the membrane 4 is sandwiched between the gas diffusion electrodes 2, 3. The assembly 1 is enclosed by the frame 6 at the outer periphery thereof, wherein the assembly 1 is sealingly retained within the frame 6 by the first seal 5.

The frame 6 has a multi-part construction and comprises the two outer frame portions 11, 12, which form the end faces 7, 8. The inner frame portion 13 is sandwiched between the outer frame portions 11, 12.

In the inner frame portion 13, the duct-like apertures 9 are arranged, which coincide with inlets and outlets of bipolar plates of an electrochemical cell, a fuel cell stack in the present case. About the apertures 9, the second seals 10.1, 10.2, 10.3, . . . are arranged, which are contiguous and integrally formed of one and the same material. The second seals 10.1, 10.2, 10.3, . . . are arranged at the end faces on both sides of the frame 6 and seal off the apertures 9 during the intended use of the unit, thus in their installed state.

The inner frame portion 13 is provided with attachment apertures 14, which are penetrated by the sealing materials of the second seals 10.1, 10.2, 10.3, . . . . This helps, on the one hand, to simply attach the second seals 10.1, 10.2, 10.3, . . . at the end faces on both sides of the frame 6. On the other hand, this results in a durable and sealing connection of the second seals 10.1, 10.2, 10.3, . . . on the inner frame portion 13 during a long service life.

FIG. 2 shows a plan view of the unit of FIG. 1. The outer frame portions 11, 12 enclose the assembly 1 at the outer periphery thereof, wherein the inner frame portion 13, which is arranged in the drawing plane between the outer frame portions 11, 12, protrudes beyond the outer frame portions 11, 12 at the outer periphery thereof. This protrusion of the inner frame portion 13 has the apertures 9 arranged in them, which are enclosed by the integrally formed second seals 10.1, 10.2, 10.3, . . . at the end faces on both sides of the inner frame portion, as shown in FIG. 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A unit, comprising:
an assembly of two gas diffusion electrodes, between which a membrane is sandwiched,
wherein the assembly is sealingly connected by a first seal to a frame enclosing the assembly at an outer periphery thereof,
wherein the frame includes two opposite end faces,
wherein the frame includes duct-like apertures extending from a first end face of the two opposite end faces to a second end face of the two opposite end faces of the frame, and
wherein the apertures are enclosed by second seals at the end faces on both sides of the frame and are sealed off with respect to each other.

2. A unit, comprising:
an assembly of two gas diffusion electrodes, between which a catalyst-coated membrane is sandwiched,
wherein the assembly is sealingly connected by a first seal to a frame enclosing the assembly at an outer periphery thereof,
wherein the frame includes two opposite end faces,
wherein the frame includes duct-like apertures extending from a first end face of the two opposing end faces to the second end face of the two opposing end faces of the frame, and
wherein the apertures are enclosed by second seals at the end faces on both sides of the frame and are sealed off with respect to each other.

3. The unit according to claim 1, wherein the second seals include an elastomeric sealing material.

4. The unit according to claim 1, wherein at least two of the second seals 1 are contiguous and integrally formed of one and the same material.

5. The unit according to claim 1, wherein all of the second seals are contiguous and integrally formed of one and the same material.

6. The unit according to claim 1, wherein the frame has a sandwich structure.

7. The unit according to claim 6, wherein the frame includes two outer frame portions between which an inner frame portion is arranged.

8. The unit according to claim 1, wherein the apertures are only arranged in the inner frame portion.

9. The unit according to any one of claim 1, wherein the second seals are sealingly connected to the inner frame portion and sealingly enclose the apertures.

10. The unit according to claim 9, wherein the second seals and the inner frame portion are adhesively and/or interlockingly connected.

11. The unit according to claim 7, wherein the inner frame portion includes attachment apertures penetrated by the sealing material of the second seals

12. The unit according to claim 2, wherein the second seals include an elastomeric sealing material.

13. The unit according to claim 2, wherein at least two of the second seals are contiguous and integrally formed of one and the same material.

14. The unit according to claim 2, wherein all of the second seals are contiguous and integrally formed of one and the same material.

15. The unit according to claim 2, wherein the frame has a sandwich structure.

16. The unit according to claim 15, wherein the frame includes two outer frame portions between which an inner frame portion is arranged.

17. The unit according to claim 2, wherein the apertures are only arranged in the inner frame portion.

18. The unit according to any one of claim 2, wherein the second seals are sealingly connected to the inner frame portion and sealingly enclose the apertures.

19. The unit according to claim 18, wherein the second seals and the inner frame portion are adhesively and/or interlockingly connected.

20. The unit according to claim 16, wherein the inner frame portion includes attachment apertures penetrated by the sealing material of the second seals.
